(19) United States
(12) Patent Application Publication
(10) Pub. No.: US 2026/0346492 A1
(43) Pub. Date: Nov. 5, 2026

(54) EXCAVATOR DOZER BLADE ATTACHMENT & FIREWOOD CUTTING SYSTEM

(71) Applicant: Andre HENRY, Richmond (AU)

(72) Inventor: Andre HENRY, Richmond (AU)

(21) Appl. No.: 19/715,872

(22) Filed: Jun. 22, 2026

Related U.S. Application Data
(63) Continuation-in-part of application No. PCT/AU2025/050331, filed on Apr. 6, 2025.

(30) Foreign Application Priority Data
Nov. 11, 2024 (AU) 2024903688

(51) Int. Cl. B27B 5/10; E02F 9/00

(52) U.S. Cl. CPC B27B 5/10; E02F 9/00

(57) ABSTRACT

An excavator dozer blade attachment for an excavator carries a cutting device mounted to the excavator dozer blade via a mounting device and forward frame extension, so that raising and lowering the dozer blade drives the cutting device through a log held by a grapple at the end of the excavator stick. The cutting device may be powered by an independent gasoline, diesel, or electric motor with a safety cage and blade guarding. A separable support structure having a cradle, roller top surface, and adjustable end stop supports the log and governs cut length, and may receive a log elevator or log splitter. Safety controls include boom slew and turntable slew limiters defining excluded regions relative to the cutting device. A controller using stored grapple and saw positions calculates sequential repositioning between cuts based on a selected cut length and maximum allowable cutting angle, enabling single-operator firewood processing.

### CROSS-REFERENCE TO RELATED APPLICATIONS

This application is a continuation-in-part (CIP) of International Application No. PCT/AU2025/050331, filed Apr. 6, 2025, which claims priority to Australian Provisional Application No. AU2024903688, filed Nov. 11, 2024. The entire contents of each of the above-identified applications are incorporated herein by reference.

### TECHNICAL FIELD

The present invention relates to excavator attachments and firewood processing equipment, and more particularly to a dozer blade mounted cutting attachment and associated system for cutting logs into firewood pieces using an excavator.

### BACKGROUND

The use of excavators to perform cutting operations is well known in the art. Excavator-mounted saws used for de-limbing trees or docking and bucking logs for firewood production are typically mounted at the end of the boom and stick of the excavator. While effective for certain forestry applications, such arrangements consume the primary motion functionality of the excavator during cutting, as the boom, and stick are occupied by the cutting operation itself and are not available to reposition or relocate logs using a grapple during the cut. Further, such boom-mounted saws can be driven into the soil or into surrounding logs during cutting, which reduces cutting performance and shortens blade life.

The use of dedicated firewood processors to dock or buck logs into saleable firewood pieces is also well known in the art. Such machines can produce cut firewood with high efficiency from logged timber; however, they require the loading of logged timber into or onto a cutting deck where the log is advanced or clamped as sawing takes place. This loading step generally requires a separate piece of handling equipment, such as an excavator fitted with a grapple or a wheeled loader fitted with forks, and the overall capital cost of acquiring and operating this combination of machines makes dedicated processors cost prohibitive to small-scale firewood producers.

A variation on this approach is an attachment-type firewood processor mounted to a skid-steer loader or excavator and using prongs or forks to lift logs into a cutting position, where a hydraulically driven saw then docks the log. Such attachment processors remain limited in output because the prong-based log handling is operator-skill dependent, and because the chainsaw-type cutting elements typically employed by such attachments are slower than circular saws when docking large, dense hardwoods such as eucalyptus.

Standalone firewood saw benches and buzz-saw arrangements are also well known in the art. Such devices are typically driven by a tractor power take-off, by an auxiliary hydraulic supply, or by a standalone engine, and commonly present the log to the blade by means of a pivoting or sliding table. While these devices can be cost effective to acquire, they require substantial manual handling of heavy logs to load and present the timber to the cutting blade, and the repetitive lifting and positioning of logs by hand is physically demanding to operate and limits throughput.

The production of blocked firewood from logged timber is thus a uniquely challenging cutting operation in which log location, size, shape, and straightness are all highly variable. Numerous devices in the prior art address individual portions of this process in a cost-effective manner, but none provide a single device that addresses the combined challenges of holding, repositioning, and cutting logs.

### SUMMARY

A system for producing cut firewood using an excavator may include an excavator dozer blade attachment that mounts to the excavator's dozer blade and carries a cutting device for elevated cutting operations. The attachment may make use of the vertical range of motion of the excavator dozer blade to raise and lower the cutting device relative to a piece of timber, which may be held, positioned, and repositioned by a grapple operated at the end of the excavator stick by the same operator. The invention may thereby allow a single operator to both handle timber and perform cutting operations without requiring separate loading equipment or manual handling of heavy logs. Non-limiting examples of suitable host machines include mini-class and midi-class excavators, for example excavators in the approximately 0.5-tonne to 8-tonne size range, in which a dozer blade is a common component.

The attachment may include a mounting device that secures the attachment to the excavator dozer blade, a frame extension that may link the mounting device to the cutting device and extend forward from the dozer blade, and a cutting device carried by the frame extension. The cutting device may be powered by the excavator or by an independent power source. Non-limiting examples of the cutting device include circular saw arrangements, and other cutting members may be used as appropriate.

The attachment may be used in combination with a log support frame configured to receive and support a log during cutting. The log support frame may be a separate component or may be configured to attach to the frame extension of the attachment.

In some embodiments, the system can be operated not only to dock or buck timber into firewood pieces, but also to move timber, for example from log piles or directly from fallen trees, using the excavator's boom, stick, swing, and grapple functions, which may remain available to the operator during cutting because the cutting device is carried on the dozer blade rather than at the end of the boom and stick.

The invention may further include one or more safety controls to inhibit hazardous contact between the boom, arm, or grapple of the excavator and the cutting device. In one embodiment, a boom slew limiter may limit the side-slewing arc of the excavator boom, such that slewing is limited on the inward side toward the cutting device and open on the outward side away from the cutting device, thereby defining a maximum proximity of boom to cutting device that no part of the boom is permitted to cross. In another embodiment, a turntable slew limiter may limit turntable slew of the excavator so as to exclude a prohibited slew sector adjacent the attachment that would otherwise permit the boom, arm, or grapple to contact the cutting device. The slew limiting function may be provided by, for example, a physical stop such as an upright bar or brace, a limit switch on the swing, a virtual wall or geo-location fence around the cutting region, a proximity sensor positioned in front of the cutting device, one or more position sensors, cameras, etc. configured to determine the relative position of the cutting device and the grapple, or combinations thereof. The safety control may further operate as an interlocking mechanism such that the machine cannot pivot toward the cutting device while the saw blade is spinning. One or more user proximity sensors may also be provided to inhibit machine movement when a person approaches the machine within a defined safety zone.

The invention may further include an automated log repositioning system for performing sequential cuts on a held log. The system may include a controller configured to store log-position data, calculate repositioning movements, and actuate automated log repositioning functions between cuts. A grapple position sensor may be configured to determine the grapple location relative to the cutting device, and a saw position sensor may be configured to determine the cutting device location, with both sensors providing output to the controller. Because the cutting device may have a known or calibrated location relative to the excavator and the dozer blade attachment, and the base of the boom is a known geometric reference point on the machine, the controller may use the stored relationship between the cutting device and the grapple to infer a straight line between the grapple and the cutting device as the held log length. The controller may further store a maximum allowable cutting angle from a square cut line at the cutting device, and may resolve forward and lateral repositioning amounts using trigonometric relationships, for example by multiplying a selected cut length by sine and cosine of the stored angle, so as to maintain or progressively improve squareness of cuts as the held log length is reduced cut by cut. If an initial stored angle exceeds a permitted tolerance, the stored position may be rejected and the operator may re-grip the log closer to the machine before repeating the store and reposition process.

A method of automated sequential cutting may include grabbing one end of a log with the grapple, placing the opposite end of the log at the cutting device, storing the grapple position relative to the cutting device, inputting a desired cut length, performing a cut by lowering the attachment through the log, raising the cutting device, lifting the log by a fixed increment, advancing the log via boom swing, turntable swing, boom movement, arm movement, grapple movement and rotation, or a combination thereof so as to reduce the effective held log length by the selected cut length while keeping the cut substantially square to the saw blade, and repeating the cutting and repositioning cycle until the log has been processed into cut pieces of the desired length.

The invention may therefore provide an integrated system that enables a single operator to handle timber, perform elevated cutting operations, and optionally stack or split the resulting cut pieces, by preserving full use of the excavator's boom, stick, swing, and grapple functions during cutting, and while optionally providing safety controls and automated repositioning features that improve operator safety and cutting consistency.

In some embodiments, the system can be used to, for example, carry object(s), grind, break, hammer, pulverize, move, or perform other tasks. For example, attachments with cutting devices, jaws, brush mulchers, grapple buckets, breakers, hammers, pulverizers, pullers, grinders, combinations thereof can be installed on or incorporated into an excavator. One or more adapters can be used to operatively couple attachments to excavator, devices to attachments, or the like. For example, the system can configured for concrete slab cutting to perform demolition work, cutting pipes for pipeline laying, or the like. In some embodiments, the excavator can hold and cut materials independently. The system can be reconfigured any number of times to perform different tasks.

Other features of embodiments of the present disclosure will be apparent from the accompanying drawings and from the detailed description that follows.

### BRIEF DESCRIPTION OF THE DRAWINGS

FIG. 1 is an illustration depicting an excavator with a simplified excavator dozer blade attachment with the power source removed in a lowered position, according to an embodiment.

FIG. 2 is an illustration depicting an excavator with a simplified excavator dozer blade attachment with the power source removed in a raised position to show the range of cutting device movement, according to an embodiment.

FIG. 3 is an illustration depicting a simplified excavator dozer blade attachment receiving a log held by a grapple with a support structure positioned to support the log.

FIG. 4 is an illustration depicting a cutting operation in which the log is positioned against an end stop of the support structure and cut by the cutting device.

FIG. 5 is a front view illustration depicting an one embodiment of the excavator dozer blade attachment.

FIG. 6 is a side angled view illustration depicting an one embodiment of the excavator dozer blade attachment.

FIG. 7 is an illustration depicting a close-up of the support structure including a roller on its top surface.

FIG. 8 is an illustration depicting a hooked-over clamp attachment structure tightened by turnbuckles for mounting the attachment to the dozer blade.

FIG. 9 is an illustration depicting a longitudinal profile of one embodiment of the excavator dozer blade attachment when removed from the excavator dozer blade.

FIG. 10A is a simplified overhead diagram illustrating an inward boom slew limiter safety-control arrangement for one embodiment of an excavator dozer blade attachment.

FIG. 10B is a simplified overhead diagram illustrating a turntable slew limiter safety-control arrangement for one embodiment of an excavator dozer blade attachment.

FIG. 11 is a simplified overhead geometric diagram illustrating automated log repositioning geometry between the cutting device, boom pivot point, and grapple location.

FIG. 12 is a flow chart illustrating a method of automated log repositioning for sequential cuts.

FIG. 13 is a block diagram illustrating a slew limiter control system for implementing boom slew limiting, turntable slew limiting, or both.

FIG. 14 is a flow chart illustrating a slew limiter method for permitting safe slew movement and inhibiting hazardous slew movement toward the cutting device.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

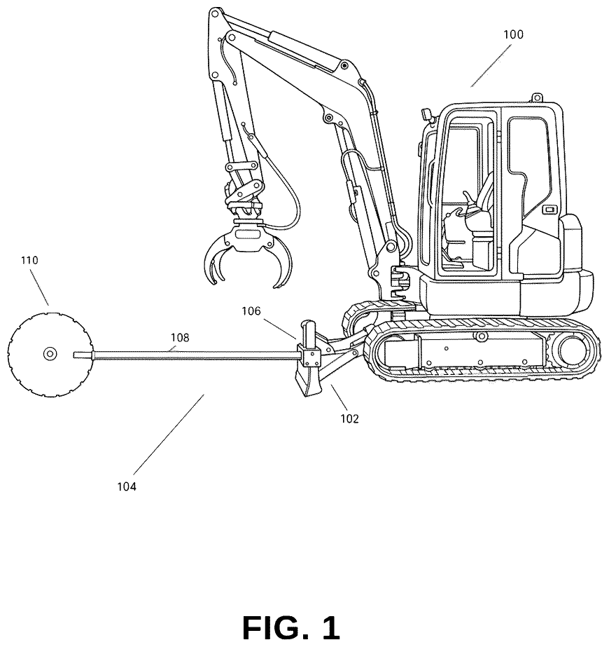

FIG. 1 illustrates an excavator 100 according to one embodiment. The excavator 100 comprises a mobile machine configured for material handling and excavation operations. The excavator 100 includes a base supporting a terrain traversal structure, such as tracks or wheels, a rotatable upper structure, and a boom assembly coupled to the upper structure. The boom assembly may include a boom, stick, and an implement interface configured to support an attachment, such as a bucket or a grapple for engaging soil, rock, timber, or debris.

The excavator 100 comprises an excavator dozer blade 102 in some embodiments. The excavator dozer blade 102 comprises a blade structure coupled to the excavator 100 and configured to engage terrain for grading, leveling, or stabilizing the excavator 100. In some embodiments, the excavator dozer blade 102 is movably coupled to a base of the excavator 100 and is adjustable between a raised position and a lowered position.

FIG. 1 further illustrates the excavator 100 with the excavator dozer blade 102 operatively coupled to the excavator dozer blade attachment 104 in a lowered position. The excavator dozer blade attachment 104 comprises a structure coupled to the excavator dozer blade 102 and configured to support a cutting apparatus for processing material. In some embodiments, the excavator dozer blade attachment 104 may be mounted securely to the excavator dozer blade 102 and allow positioning of the excavator dozer blade attachment 104 in a raised or lowered position by raising or lowering the excavator, does your blade 102. In some embodiments, the excavator dozer blade attachment 104 attaches a cutting device configured to cut timber or other material. The excavator dozer blade attachment 104 may be removably coupled, fixedly coupled, or integrally formed with the excavator dozer blade 102.

The excavator dozer blade attachment 104 may comprise a mounting device 106. The mounting device 106 provides a mounting interface for attaching the excavator dozer blade attachment 104 to the excavator dozer blade 102. The mounting device 106 may be, for example, in the form of a clamped wedge attachment to the top edge of the excavator dozer blade 102, in one embodiment. In other embodiments, the mounting device 106 may be a bolted connection including brackets and fasteners, a clamping assembly including opposing clamp members, a welded joint, a pin-and-lug interface, a hook-and-latch mechanism, a sliding rail or channel interface, a keyed interlocking interface, a hydraulic or mechanical quick-attach coupler, or a tensioned linkage including one or more chains, straps, or turnbuckles. One skilled in the art will appreciate that combinations of the foregoing attachment mechanisms may be used.

The excavator dozer blade attachment 104 may further comprise a frame extension 108. The frame extension 108 comprises an elongated structural member coupled to the excavator dozer blade attachment 104 and configured to extend outward from the excavator dozer blade 102 to position the cutting device at an offset from the excavator dozer blade 102. The frame extension 108 may be configured to transmit loads between the cutting device and the excavator dozer blade attachment 104 and to maintain a predetermined spatial relationship therebetween during operation. In some embodiments, the frame extension 108 may comprise a rigid beam, bar, or tubular structure.

The excavator dozer blade attachment 104 may further comprise a cutting device 110. The cutting device 110 comprises a material processing element coupled to the frame extension 108 and configured to cut or section material. In some embodiments, the cutting device 110 comprises a rotary saw blade. In other embodiments, the cutting device 110 may comprise a chainsaw assembly, a circular timber saw, a slab saw, or a saw or disc cutter configured to cut, for example, timber, rock, concrete, metal, or plastic. The cutting device can be selected based on the material to be cut. In some embodiments, the excavator dozer blade attachment 104 can comprise a jaw, a brush mulcher, a grapple bucket, a breaker, a hammer, a pulverizer (e.g., a concrete pulverizer), a puller (e.g., a tree puller), a grinder, combinations thereof, or the like. For example, the excavator dozer blade attachment 104 can include multiple cutters for independently cutting the same or different objects.

FIG. 1 further illustrates a simplified representation of the present disclosure, wherein the frame extension 108 of the excavator dozer blade attachment 104 is depicted in a straight-out orientation extending from the excavator dozer blade 102 and supporting the cutting device 110. To simplify this figure further and highlight the overall orientation, the power or actuating component of the cutting device 110 is not depicted but may comprise, for example, a hydraulic motor supplied with power from the excavator 100 or alternatively an independent power source in the form of a gasoline, diesel, or electric motor. It is noted that the frame extension 108 of the excavator dozer blade attachment 104 can be mounted at a raised position above the excavator dozer blade 102 or can be mounted at an inclined angle upward from the excavator dozer blade 102 to raise the lowered position of the cutting device 110 of the excavator dozer blade attachment 104 when the excavator dozer blade 102 is in the lowered position.

In some embodiments, the excavator dozer blade attachment 104 is secured to the excavator 100 by engaging the mounting device 106 over a top edge of the excavator dozer blade 102 as a clamped wedge attachment, such that lowering of the excavator dozer blade 102 correspondingly lowers the cutting device 110 via the frame extension 108. With the excavator dozer blade 102 in the lowered position as shown in FIG. 1, the cutting device 110 is positioned at an elevation suitable for engaging timber, while boom, stick, swing, and grapple functions of the excavator 100 remain available for positioning the material during cutting.

The cutting device 110 may be actuated by a hydraulic motor supplied by the excavator 100, with hydraulic lines routed along the frame extension 108, or by an independent power source, such as a gasoline or diesel motor, according to an embodiment. In some embodiments, the frame extension 108 may be adjustable in length to define a selectable first height (e.g., a maximum raised height), and/or a selectable second height (e.g., a minimum lowered height) for the cutting device 110.

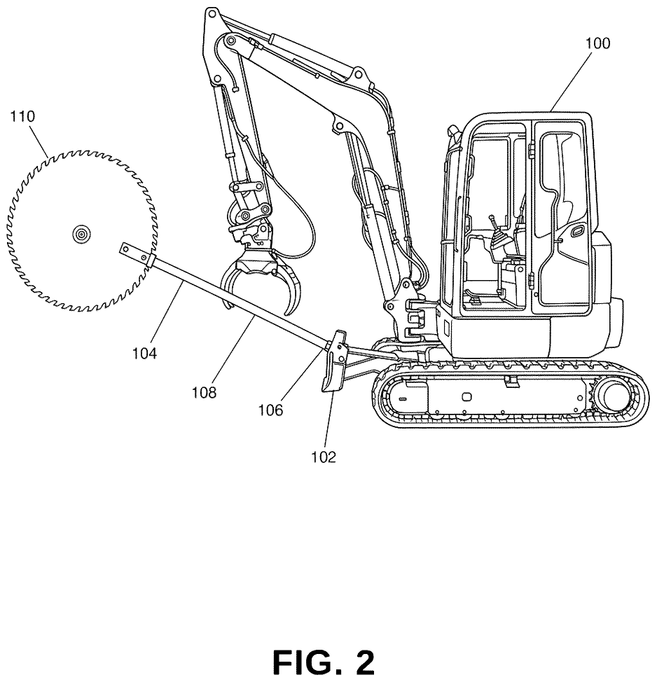

FIG. 2 illustrates the excavator 100 with the excavator dozer blade attachment 104 in a raised position. In a preferred embodiment, the mounting device 106 of the excavator dozer blade attachment 104 is in the form of a clamping arrangement, wherein the frame extension 108 is attached perpendicular to the excavator dozer blade 102.

FIG. 2 further illustrates that the excavator dozer blade 102 pivots along an arc about a pivot point, resulting in an increased range of vertical travel of the cutting device 110. Specifically, the range of cutting performed by the cutting device 110 is governed by its horizontal offset from the excavator dozer blade 102, such that extension of the frame extension 108 increases displacement of the cutting device 110 during blade movement. For example, the excavator dozer blade 102 may have a lifting range of approximately 380 mm at an edge of the excavator dozer blade 102, while the cutting device 110, being offset by the frame extension 108, may exhibit a range of travel of approximately 1000 mm.

As described in relation to FIG. 1, a starting position of the cutting device 110 may be selected by mounting the frame extension 108 at a raised position relative to the excavator dozer blade 102 or at an inclined angle relative to the excavator dozer blade 102.

In some embodiments, the cutting device 110 is positioned at a distal end of the frame extension 108 such that pivoting the excavator dozer blade 102 results in increased vertical travel at the cutting device 110. The frame extension 108 increases a radius between a pivot point of the excavator dozer blade 102 and the cutting device 110, resulting in a corresponding increase in arc length traveled by the cutting device 110 during pivoting movement.

During operation, the cutting device 110 may be raised above a workpiece and subsequently lowered through the workpiece in a single stroke driven by movement of the excavator dozer blade 102.

In some embodiments, a starting position of the cutting device 110 may be selected prior to operation by adjusting how the frame extension 108 is secured to the excavator dozer blade 102 via the mounting device 106. The frame extension 108 may be secured at a raised vertical position or at an angle relative to the excavator dozer blade 102 to position the cutting device 110 and define a cutting envelope corresponding to a material size to be processed, such as timber logs having a particular average diameter.

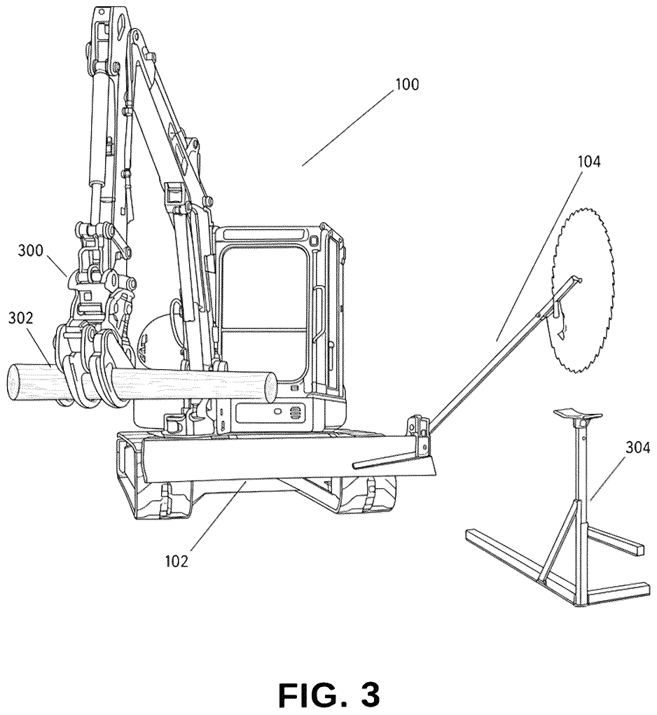

FIG. 3 depicts the excavator 100 with the excavator dozer blade attachment 104 operating as a cutting system. The excavator 100 may comprise a grapple 300 coupled to the boom assembly and configured to engage and control a workpiece. In some embodiments, the log 302 represents a workpiece and may comprise timber, a tree section, or other elongate material to be processed.

FIG. 3 further illustrates a support structure 304 configured to support the log 302 during cutting. The support structure 304 may comprise a sawhorse, dolly, stand, box, pillar, table, bench, or other frame or structure capable of supporting a log 302 during a cutting operation.

An operator manipulates the log 302 using the grapple 300 and positions the log 302 adjacent the cutting device of the excavator dozer blade attachment 104.

In some embodiments, the excavator 100 operates as a cutting system in which the grapple 300 engages and positions the log 302 onto the support structure 304. The excavator dozer blade 102 may be positioned such that the excavator dozer blade attachment 104 is above the log 302 prior to cutting.

In some embodiments, the grapple 300 maintains or adjusts positioning of the log 302 while the excavator dozer blade 102 is lowered to move the excavator dozer blade attachment 104 through the log 302 for cutting. The support structure 304 may be separate from the excavator 100, allowing the log 302 to be repositioned between cuts.

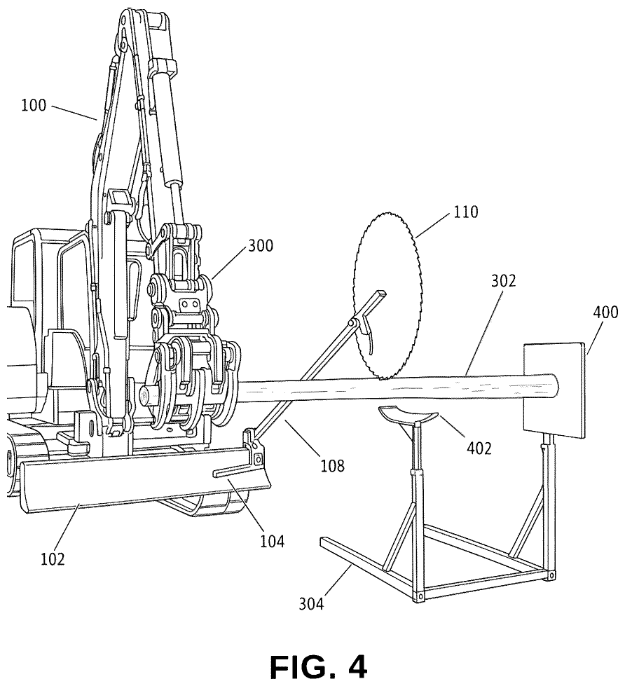

FIG. 4 depicts the excavator dozer blade attachment 104 operating as a cutting system.

FIG. 4 further illustrates a support structure 304 comprising an end stop 400 configured to define a cut length of the log 302 and a cradle 402 configured to support the log 302 during cutting. In some embodiments the support structure 304 may be adjustable in height and in spacing between the cradle 402 and the end stop 400. In some embodiments, the support structure 304 may be positionable on a ground surface (e.g., a generally flat surface, dirt, pavement) adjacent the excavator 100, allowing the operator to position the support structure 304 at a selected location relative to the cutting device 110.

An operator positions the log 302 using the grapple 300 against the end stop 400 to set a cut length and lowers the log 302 onto the cradle 402. The excavator dozer blade 102 is then lowered to drive the cutting device 110 through the log 302. Upon completion of the cut, the excavator dozer blade 102 is raised to lift the cutting device 110, and the grapple 300 repositions the log 302 for a subsequent cut.

In some embodiments, the support structure 304 may be configured to interface with additional equipment, such as a log elevator, log splitter, conveyor, or other material handling or firewood-processing equipment, and may be separate from or coupled to the frame extension 108. In some embodiments, a log splitter or a log elevator may be coupled to the excavator dozer blade attachment 104 or to the frame extension 108.

In some embodiments, the support structure 304 may be adjustable in height and in spacing between the cradle 402 and the end stop 400 to define a selected cut length. The support structure 304 may be positionable on a ground adjacent the excavator 100 to define a target cutting position relative to the cutting device 110. The support structure 304 may further be attachable to the frame extension 108 to permit relocation by the excavator 100.

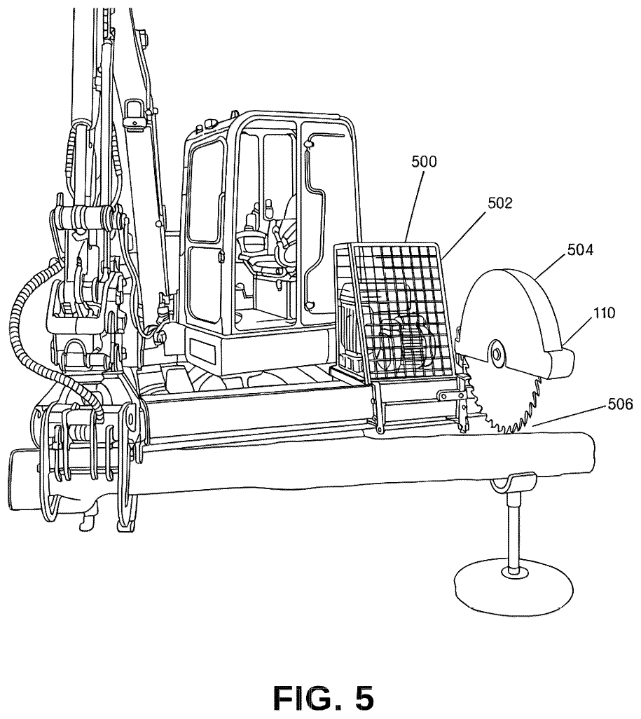

FIG. 5 illustrates a front view of the excavator dozer blade attachment 104. The excavator dozer blade attachment 104 may comprise an independent power source 500 supported by the frame extension 108 and configured to provide rotational drive to the cutting device 110. The independent power source 500 may comprise, for example, an electric motor, or a gasoline or diesel engine. In some embodiments, the cutting device 110 may be operatively coupled to a drive motor configured to rotatably drive the cutting device 110, wherein the drive motor may comprise a hydraulic motor or an independent power source such as an electric motor or a gasoline or diesel engine. In some embodiments, the independent power source 500 may be started, stopped, or otherwise controlled from an operating position of the excavator 100. In some embodiments, the cutting device 110 may be driven by a hydraulic motor connected to the hydraulic system of the excavator 100 via a hammer line or full-flow hydraulic line.

The independent power source 500 may be positioned within a safety cage 502. The safety cage 502 comprises a protective structure configured to shield the independent power source 500 from contact and debris.

The cutting device 110 may comprise guarding 504 and a circular saw blade 506. The guarding 504 comprises a cover or shield surrounding at least a portion of the cutting device 110 and configured to limit exposure to a rotating element. The circular saw blade 506 comprises a rotating cutting element configured to sever a workpiece.

In some embodiments, the frame extension 108 supports the cutting device 110 and the independent power source 500, and the independent power source 500 drives the cutting device 110, with the safety cage 502 reducing contact with the independent power source 500 and the guarding 504 reducing exposure to the circular saw blade 506 during cutting.

In operation, the independent power source 500 drives rotation of the circular saw blade 506 of the cutting device 110, while the safety cage 502 and guarding 504 provide protection from debris generated by the cutting process.

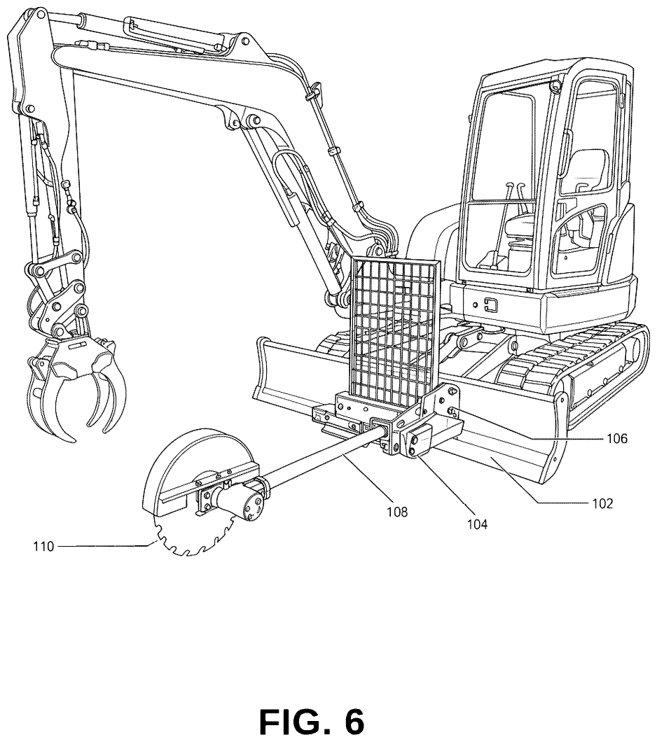

FIG. 6 illustrates a side perspective view of the excavator dozer blade attachment 104, showing the mounting device 106 attached to the excavator dozer blade 102 and the frame extension 108 extending from the excavator dozer blade 102 and supporting the cutting device 110. FIG. 6 further illustrates one embodiment of the mounting device 106, wherein the mounting device may comprise bolting the excavator dozer blade attachment 104 to the excavator dozer blade 102.

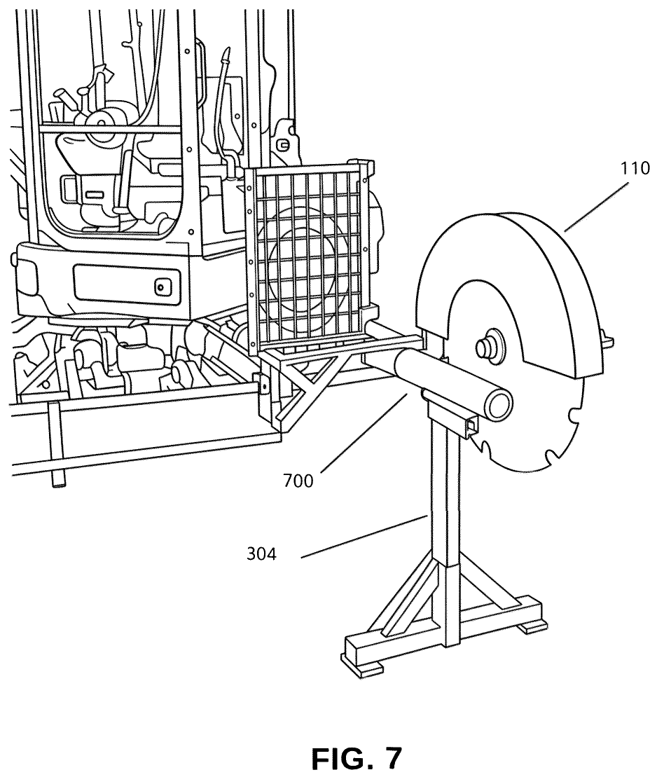

FIG. 7 illustrates a support structure 304. The support structure 304 may comprise a roller 700 positioned on an upper surface and configured to support and allow translation of a workpiece. In some embodiments, the roller 700 permits a workpiece, such as log 302, to be advanced along the support structure 304 with reduced friction.

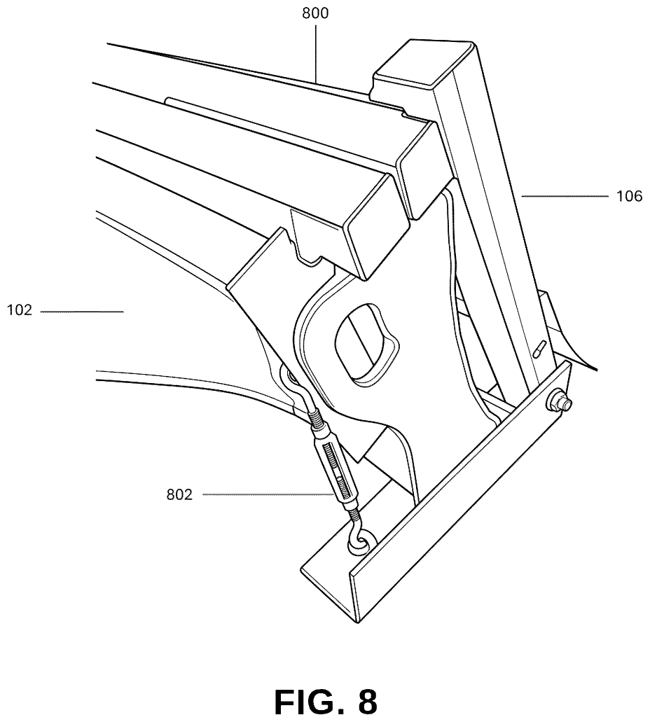

FIG. 8 illustrates an attachment configuration for the excavator dozer blade attachment 104. The mounting device 106 may comprise a hooked-over clamp 800 positioned over the excavator dozer blade 102 and secured by one or more turnbuckles 802. The turnbuckles 802 are configured to apply tension to retain the hooked-over clamp 800 operatively coupled to the excavator dozer blade 102. In some embodiments, the hooked-over clamp 800 serves as the mounting device 106 and is secured over the excavator dozer blade 102, with the turnbuckles 802 tightening the hooked-over clamp 800 to the excavator dozer blade 102.

In some embodiments, the turnbuckles 802 are adjustable to accommodate variations in geometry of the excavator dozer blade 102, and may be loosened to permit removal of the hooked-over clamp 800 from the excavator dozer blade 102.

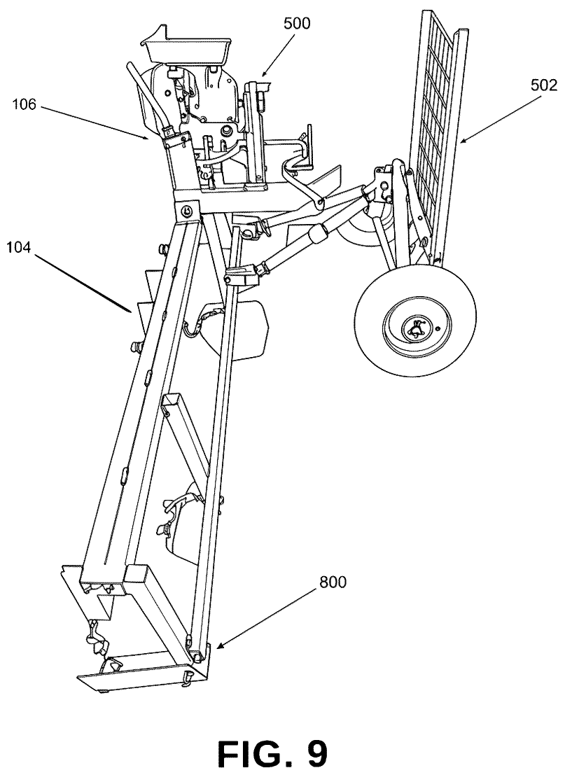

FIG. 9 illustrates a longitudinal view of the excavator dozer blade attachment 104 in a detached configuration, showing the mounting device 106 in the form of a hooked-over clamp 800, along with the independent power source 500 and the safety cage 502.

In some embodiments, the excavator dozer blade attachment 104 is configured as a self-contained unit removable from the excavator dozer blade, with the independent power source 500 remaining mounted to the excavator dozer blade attachment 104 such that operation does not require connection to excavator 100 and may be transferred between excavators in some embodiments.

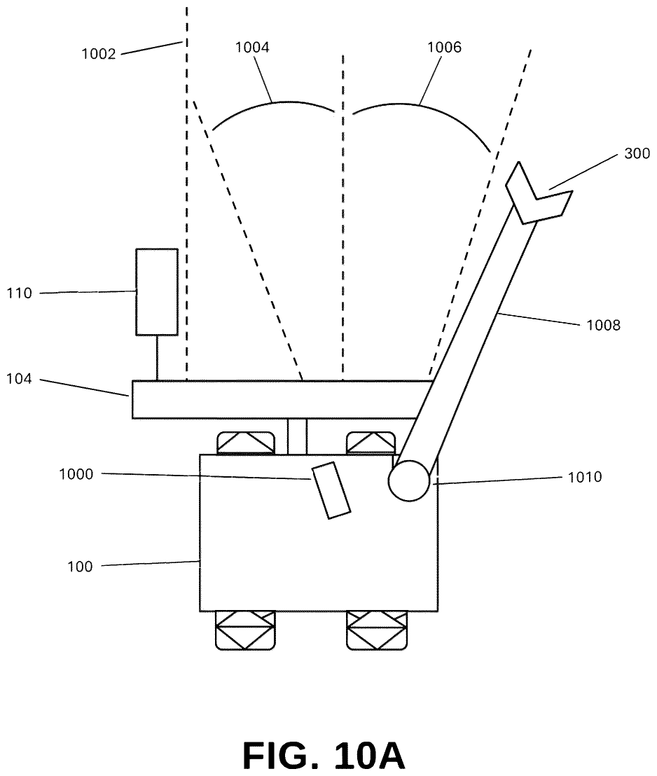

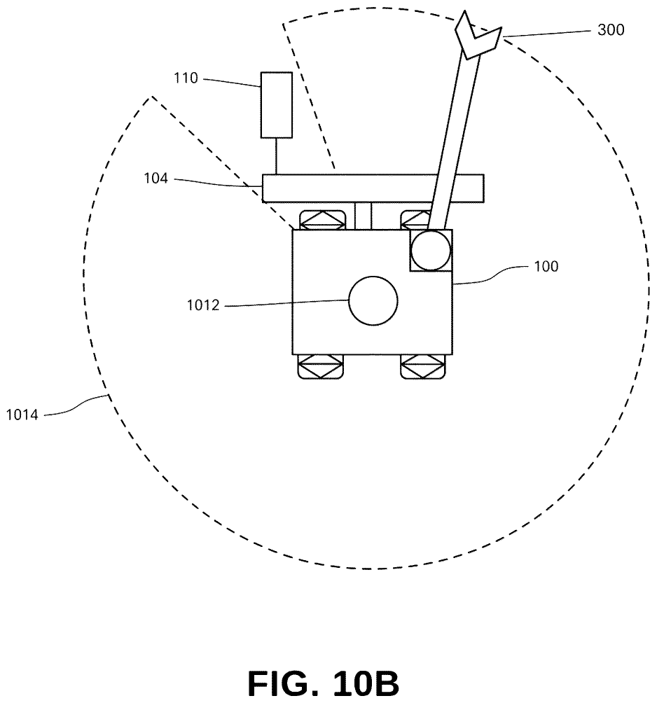

FIG. 10A illustrates an overhead diagram of a boom slew limiting system for the excavator dozer blade attachment 104.

The excavator 100 may comprise a boom 1008. The boom 1008 comprises a pivotable member configured to manipulate a workpiece via the grapple 300 and is rotatable about a boom pivot point 1010.

In some embodiments, the excavator 100 may comprise a boom slew limiter 1000. The boom slew limiter 1000 may be a component configured to limit a range of motion of the boom 1008 and may comprise, for example, a mechanical hard stop, an electrical component, or a control system configured to restrict pivoting of the boom 1008 over a selected range of motion.

In some embodiments, the boom slew limiter 1000 limits the boom 1008 relative to the maximum proximity of boom to saw 1002. The boom slew limiter 1000 may restrict movement of the boom 1008 within a range of motion defined by the boom slew limited 1004, while permitting movement within a range defined by boom slew open 1006. For example, the boom slew limiter 1000 restricts the movement of boom 1008 in a range of motion wherein boom 1008 may collide with cutting device 110, a location defined by the maximum proximity of boom to saw 1002, wherein the location of the cutting device 110 may be determined in addition to some buffer zone.

A potential safety concern arises in configurations in which the cutting device 110 is positioned at a known location relative to the excavator 100 or the excavator dozer blade attachment 104, such that pivoting of the boom 1008 may result in contact between the boom 1008 and/or the grapple 300 and the cutting device 110. The boom 1008 is capable of slewing about the boom pivot point 1010 across a range of motion on either side of a central position.

In some embodiments, the boom slew limiter 1000 restricts movement such that the boom 1008 does not cross the maximum proximity of boom to saw 1002 via the range of motion defined by boom slew limited 1004, while permitting movement within boom slew open 1006. The maximum proximity of boom to saw 1002 defines a location that the boom 1008 is prevented from entering relative to the cutting device 110.

As the boom 1008 pivots about the boom pivot point 1010 and approaches the boom slew limited 1004, the boom slew limiter 1000 may slow, limit, or reverse motion of the boom 1008. The boom slew limiter 1000 may be implemented using a mechanical stop, a limit switch, a virtual boundary, a proximity sensor, or one or more position sensors configured to determine relative positions of the boom 1008 and the cutting device 110.

In some embodiments, the boom slew limiter 1000 may further operate as an interlock preventing movement of the boom 1008 toward the cutting device 110 while the cutting device 110 is operating. In some embodiments, the boom slew limiter 1000 may comprise or operate as a safety interlock circuit configured to inhibit movement of the boom 1008, a stick, the grapple 300, or an upper structure of the excavator 100 into a restricted region adjacent the cutting device 110 while the cutting device 110 is operating. In some embodiments, one or more proximity sensors may inhibit movement of the excavator 100 when a person is detected within a defined safety zone.

One skilled in the art will appreciate that FIG. 10A represents a simplified two-dimensional plane and does not imply the boom slew limiter 1000, the maximum proximity of boom to saw 1002, or the boom slew limited 1004 to a purely planar implementation. In some embodiments, the boom slew limiter 1000 may limit motion of the boom 1008 in one or more of an X, Y, or Z direction. For example, in some embodiments, when the boom 1008 and/or grapple 300 is positioned at an elevated height sufficient to clear the cutting device 110, the boom 1008 may be permitted to pivot across a region otherwise restricted in a lower position.

In further embodiments, the maximum proximity of boom to saw 1002 may vary based on an operating state of the cutting device 110. For example, during operation of the cutting device 110, increased vibration, debris, or dynamic movement may result in expansion of the boom slew limited 1004 to increase separation between the boom 1008, the grapple 300, and the cutting device 110.

In some embodiments, the excavator 100 performs a cutting operation on a plurality of workpieces (e.g., such as log 302) positioned adjacent the excavator dozer blade attachment 104. The operator uses the boom 1008, pivoting about the boom pivot point 1010, to position the grapple 300 to retrieve a subsequent log 302. Movement of the boom 1008 toward the cutting device 110 may require pivoting through the boom slew limited 1004, which would result in the boom 1008 or grapple 300 crossing the maximum proximity of boom to saw 1002.

The boom slew limiter 1000 inhibits such inward pivoting of the boom 1008 within the boom slew limited 1004 and permits motion within the boom slew open 1006. Upon reaching the restricted region, the boom slew limiter 1000 may prevent further motion and provide feedback to the operator. The operator may then reposition the excavator 100 to permit access to the log 302 while maintaining separation between the boom 1008, the grapple 300, and the cutting device 110.

FIG. 10B illustrates an overhead diagram of a turntable slew limiting system for the excavator dozer blade attachment 104. In some embodiments, the excavator 100 may comprise a turntable slew limiter 1012. The turntable slew limiter 1012 comprises a component configured to limit rotation of an upper structure of the excavator 100 relative to the cutting device 110.

The excavator 100 may further comprise a maximum turntable slew 1014. The maximum turntable slew 1014 defines an allowable rotational range of the upper structure about a turntable axis, wherein a portion of the maximum turntable slew 1014 includes an excluded sector corresponding to a region adjacent the cutting device 110.

A potential safety concern arises in configurations in which the cutting device 110 is mounted to a fixed position relative to the excavator 100, such that rotation of the upper structure may result in contact between the boom 1008 and/or grapple 300 and the cutting device 110. The turntable slew limiter 1012 prevents such rotation into the excluded sector.

The turntable slew limiter 1012 may comprise a mechanical hard stop, a limit switch, a virtual boundary, a proximity sensor, or one or more position sensors configured to determine relative positions of the boom 1008 and the cutting device 110. In some embodiments, the turntable slew limiter 1012 operates as an interlock preventing rotation through the excluded sector while the cutting device 110 is operating. In some embodiments, one or more proximity sensors may inhibit movement of the excavator 100 when a person is detected within a defined safety zone.

In some embodiments, the boom slew limiter 1000 and the turntable slew limiter 1012 operate in coordination to restrict combined motion of the boom 1008 and the excavator 100 to prevent contact with the cutting device 110 for any combination of boom pivot and turntable rotation.

In some embodiments, the turntable slew limiter 1012 may determine a position of the boom 1008 and/or the grapple 300 in three-dimensional space. The maximum turntable slew 1014 may vary based on a vertical position of the boom 1008 relative to the cutting device 110. For example, when the boom 1008 and/or the grapple 300 is positioned at a height sufficient to clear the cutting device 110, the turntable slew limiter 1012 may permit rotation through a greater portion of the maximum turntable slew 1014, including up to a full 360° range of motion.

In some embodiments, the excavator 100 performs a cutting operation with the excavator dozer blade attachment 104 positioned below the turntable (e.g. attached to the excavator dozer blade 102). The operator rotates the upper structure of the excavator 100 to position the grapple 300 to retrieve or reposition a log 302 within the maximum turntable slew 1014. As rotation approaches a sector in which the boom 1008 or grapple 300 would enter a region adjacent the cutting device 110, the turntable slew limiter 1012 inhibits further rotation, preventing the grapple 300 from entering the excluded sector.

In some embodiments, the turntable slew limiter 1012 operates using one or more position sensors that determine relative positions of the grapple 300 and the cutting device 110. Rotation through the excluded sector of the maximum turntable slew 1014 may be disabled while the cutting device 110 is operating and permitted when the cutting device 110 is idle. The operator may thereby reposition the excavator 100 or adjust boom 1008 position to access additional logs without entering the excluded sector. One or more proximity sensors may further inhibit movement and/or deactivate the cutting device 110 when a person is detected within a defined safety zone adjacent the excavator dozer blade attachment 104.

In further embodiments, the excavator 100 may generate alerts when the boom slew limiter 1000 or the turntable slew limiter 1012 restricts motion, including visual, audible, or electronic notifications to an operator. In some embodiments, the system may record events associated with operation of the boom slew limiter 1000 or the turntable slew limiter 1012, including time, date, location, and sensor data corresponding to contact events or near-miss conditions, for purposes of analysis, compliance, or troubleshooting.

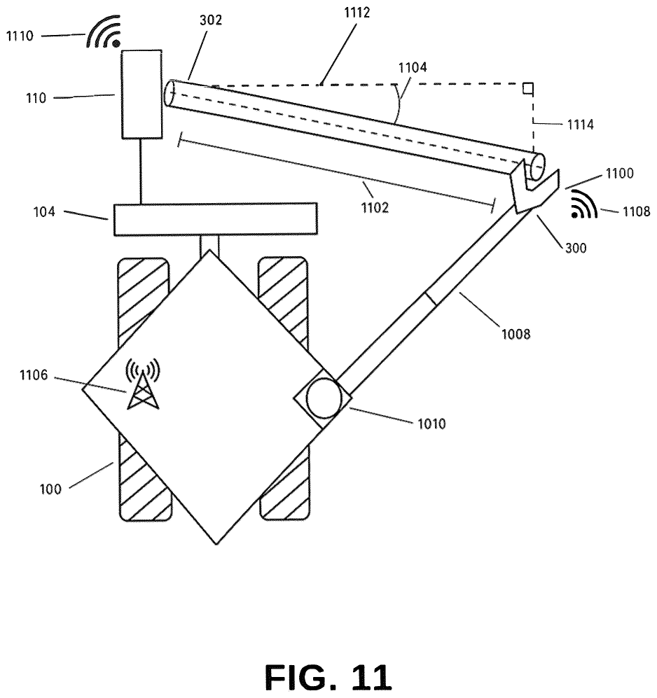

FIG. 11 illustrates a geometric automation system for positioning a workpiece relative to the cutting device 110. In some embodiments, the system may define a grapple location 1100. The grapple location 1100 comprises a spatial position of the grapple 300 relative to the excavator 100, the cutting device 110, or another frame of reference. The system may further define an initial log length 1102, which may comprise an effective held length of the log 302 between the cutting device 110 and the grapple location 1100 when an end of the log 302 is positioned at or adjacent the cutting device 110.

The system may further define a maximum allowable cutting angle 1104. The maximum allowable cutting angle 1104 comprises a permitted maximum angular deviation between the log 302 and a square cut line 1112 at the cutting device 110. An actual cutting angle of the log 302 may be measured or calculated relative to the square cut line 1112 and compared with the maximum allowable cutting angle 1104. In some embodiments, cutting or automated repositioning may be permitted only when the actual cutting angle is less than or equal to the maximum allowable cutting angle 1104.

The system may further define a transverse spacing 1114 extending between the grapple location 1100 and a projected point on the square cut line 1112.

The excavator 100 further comprises a controller 1106. The controller 1106 comprises a processing component configured to determine positions and generate control inputs based on geometric relationships. The excavator 100 may further comprise a grapple position sensor 1108 and a saw position sensor 1110, which are configured to provide position data corresponding to the grapple 300 and the cutting device 110, respectively.

The boom pivot point 1010 may comprise a known pivot location of the boom 1008 relative to the excavator 100. In some embodiments, the boom pivot point 1010 provides a machine reference point used by the controller 1106 to determine or verify the position of the grapple 300 relative to the cutting device 110. The controller 1106 may define a geometric relationship among the cutting device 110, the boom pivot point 1010, and the grapple location 1100, such that the cutting device 110, boom pivot point 1010, and grapple location 1100 form respective vertices of a triangle used for automated log repositioning.

In some embodiments, the grapple position sensor 1108 is configured to determine a spatial position of the grapple 300, including one or more of x, y, and z positional coordinates. The saw position sensor 1110 may be configured to determine a position of the cutting device 110, which in some embodiments comprises fewer degrees of freedom than the grapple 300. For example, where the cutting device 110 is mounted in a fixed horizontal position relative to the excavator dozer blade 102, the saw position sensor 1110 may determine a vertical position of the cutting device 110 corresponding to a raised or lowered position of the excavator dozer blade 102.

One skilled in the art will appreciate that FIG. 11 illustrates the geometric relationship between the log 302, the grapple 300, the boom pivot point 1010, the cutting device 110, and the square cut line 1112 in a simplified two-dimensional plane. In some embodiments, the actual cutting angle may be evaluated in any combination of x, y, and z coordinates to account for pitch, yaw, or roll of the log 302 relative to the square cut line 1112.

In some embodiments, the controller 1106 determines the initial log length 1102 based on position data from the grapple position sensor 1108 and the saw position sensor 1110. An operator may position the log 302 such that an end of the log 302 contacts or is adjacent the cutting device 110, and may store the corresponding grapple location 1100. The controller 1106 may then determine the initial log length 1102 and determine whether an actual cutting angle of the log 302 relative to the square cut line 1112 is within the maximum allowable cutting angle 1104.

In some embodiments, the controller 1106 calculates repositioning of the grapple 300 to reduce an effective held length of the log 302 from the initial log length 1102 by a selected cut length. The repositioning may include longitudinal and lateral movement components determined using trigonometric relationships based on an actual, stored, or target cutting angle that is constrained by the maximum allowable cutting angle 1104. For example, where the initial log length 1102 is approximately 3 meters, the actual cutting angle is approximately equal to a maximum allowable cutting angle 1104 of approximately 10°, and the selected cut length is approximately 0.3 meters, the controller 1106 may determine a first movement component of approximately 0.3·cos (10°), or about 0.295 meters, along the square cut line 1112, and a second movement component of approximately 0.3·sin (10°), or about 0.052 meters, transverse to the square cut line 1112.

In some embodiments, the controller 1106 may raise the log 302 before repositioning to reduce interference, and may reposition the grapple 300 using one or more of slew, extension, or other manipulation of the boom 1008, turntable slew, or combinations thereof. The controller 1106 may thereby reduce the effective length of the log 302 between sequential cuts while maintaining or reducing angular deviation from the square cut line 1112.

In some embodiments, the controller 1106 may determine whether a proposed repositioning of the grapple 300 will reduce the actual cutting angle relative to the square cut line 1112 by evaluating a triangle associated with the log 302 in the plane illustrated in FIG. 11. For example, for a given cut (n), a first side Aₙ may correspond to an effective held length of the log 302, such as the initial log length 1102 or an updated held length after one or more cuts. A second side By may correspond to a projected distance along the square cut line 1112 between the cutting device 110 and a projected position of the grapple location 1100. A third side Cₙ may correspond to a transverse spacing 1114 between the grapple location 1100 and the square cut line 1112. The transverse spacing 1114 may be represented in FIG. 11 as a side of the triangle extending from the grapple location 1100 to a projected point on the square cut line 1112. The controller 1106 may calculate an actual cutting angle θₙ between the effective held length of the log 302 and the square cut line 1112 according to:

$${θ}_{n} = {cos}^{- 1} ( \frac{{A}_{n}^{2} + {B}_{n}^{2} - {C}_{n}^{2}}{2 {A}_{n} {B}_{n}} )$$

The controller 1106 may compare the actual cutting angle (θₙ) with the maximum allowable cutting angle 1104. In some embodiments, the controller 1106 may determine a subsequent repositioning of the grapple 300 such that an updated transverse spacing Cₙ₊₁ is reduced relative to updated sides Aₙ₊₁ and Bₙ₊₁, thereby reducing the actual cutting angle for a subsequent cut. For example, the controller 1106 may determine that a proposed repositioning reduces the actual cutting angle when:

$${cos}^{- 1} ( \frac{{A}_{n + 1}^{2} + {B}_{n + 1}^{2} - {C}_{n + 1}^{2}}{2 {A}_{n + 1} {B}_{n + 1}} ) < {cos}^{- 1} ( \frac{{A}_{n}^{2} + {B}_{n}^{2} - {C}_{n}^{2}}{2 {A}_{n} {B}_{n}} )$$

Equivalently, the controller 1106 may determine that the proposed repositioning reduces the actual cutting angle when:

$$\frac{{A}_{n + 1}^{2} + {B}_{n + 1}^{2} - {C}_{n + 1}^{2}}{2 {A}_{n + 1} {B}_{n + 1}} > \frac{{A}_{n}^{2} + {B}_{n}^{2} - {C}_{n}^{2}}{2 {A}_{n} {B}_{n}}$$

In a simplified implementation, where a ratio between Aₙ and Bₙ is maintained or changes within a predetermined tolerance, the controller 1106 may approximate the reduction in angular deviation by determining whether:

$$\frac{{C}_{n + 1}^{2}}{{A}_{n + 1} {B}_{n + 1}} < \frac{{C}_{n}^{2}}{{A}_{n} {B}_{n}}$$

In this manner, the controller 1106 may calculate or verify that the transverse spacing 1114 shortens at a rate sufficient to cause the actual cutting angle to decrease over successive cuts, so that sequential cuts become closer to the square cut line 1112 as the effective held length of the log 302 is reduced.

In some embodiments, the controller 1106 may adjust repositioning over successive cuts to maintain the actual cutting angle at or below the maximum allowable cutting angle 1104, or to progressively reduce the actual cutting angle as the log 302 shortens. For example, the controller 1106 may apply a geometric relationship, including a law-of-cosines relationship, to compare prior and updated triangle geometry defined by the cutting device 110, the boom pivot point 1010, and the grapple location 1100. Based on that comparison, the controller 1106 may determine whether a proposed movement of the grapple 300 maintains or reduces angular deviation of the log 302 relative to the square cut line 1112. If the angular deviation of the log 302 exceeds the maximum allowable cutting angle 1104, the controller 1106 may reject the stored position, alert the operator, or require the operator to reposition the grapple 300 closer to the cutting device 110 before storing a new grapple location 1100.

In this manner, the controller 1106 uses stored geometry, including the boom pivot point 1010, and sensor data to assist or automate repositioning of the log 302 between sequential cuts.

In some embodiments, the controller 1106 may perform the foregoing repositioning to produce a plurality of sequential cut pieces from the log 302. For example, the controller 1106 may reposition a 3 meter log 302 in 0.3 meter increments to produce ten cut pieces. In other embodiments, the controller 1106 may reposition the log 302 to produce a single workpiece of a selected length, such as by shortening a 3.3 meter log 302 to a 3 meter workpiece. In further embodiments, the controller 1106 may produce cut pieces having different selected lengths according to a stored cut list. One skilled in the art will appreciate that the controller 1106 may account for dimensional allowances, including a kerf of the cutting device 110, tolerances of the grapple position sensor 1108 and the saw position sensor 1110, and tolerance deviations for splitting, stacking, sorting of the completed workpieces, or other processing of the log 302 or a cut workpiece.

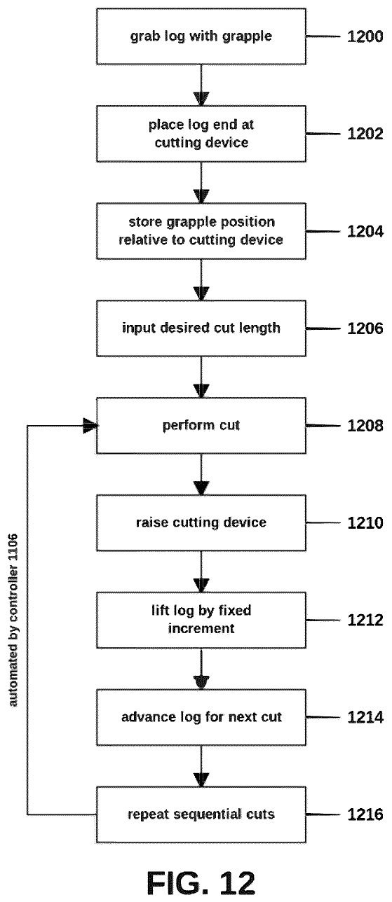

FIG. 12 illustrates a flow chart of a method of automated log repositioning for sequential cuts of a log 302. The method may be performed by the controller 1106 using position data from the grapple position sensor 1108 and the saw position sensor 1110.

At step 1200, the log 302 is grabbed with the grapple 300. The grapple 300 may engage an end portion of the log 302 to allow the excavator 100 to manipulate the log 302 relative to the cutting device 110.

At step 1202, an end of the log 302 is placed at the cutting device 110. The log 302 may be positioned such that an opposite end of the log 302 is located at or adjacent the cutting device 110.

At step 1204, a first grapple location 1100 is stored relative to the cutting device 110. The controller 1106 may store the first grapple location 1100 and determine the initial log length 1102 based on the relationship between the grapple 300 and the cutting device 110. The controller 1106 may further evaluate the cutting angle of the log relative to the square cut line 1112 and determine if it exceeds the maximum allowable cutting angle 1104. If it does, the system may alert the operator.

At step 1206, a desired cut length is input. The desired cut length may correspond to a target dimension (e.g., a length, a width, etc.) of a cut piece, such as a firewood length, trimming length, slab (e.g., concrete slab) width and/or length, pipe length, beam length, or other selected workpiece length. The desired cut length may be input explicitly by the operator or may be implicit based on how the operator has positioned grapple 300 relative to cutting device 110.

At step 1208, a cut is performed. The excavator dozer blade 102 may be lowered, thereby lowering the excavator dozer blade attachment 104, to move the cutting device 110 through the log 302.

At step 1210, the cutting device 110 may be raised. The excavator dozer blade 102 may be raised to withdraw the cutting device 110 from the area disposed between the cut length of log 302 and the current workpiece to provide clearance for repositioning.

At step 1212, the log 302 is lifted by a fixed increment. The controller 1106 may actuate the boom 1008, grapple 300, or another component of the excavator 100 to raise the log 302 before repositioning. In some embodiments the log 302 may be lifted by, for example, a minimum of 0.1 m in order to provide clearance above the support structure 304.

At step 1214, the log 302 is advanced for a next cut. The controller 1106 may reposition the grapple 300 using one or more of slew, extension or other manipulation of the boom 1008, turntable slew, or combinations thereof. The repositioning may be calculated based on the desired cut length, the initial log length 1102, and the maximum allowable cutting angle 1104.

At step 1216, the method repeats sequential cuts. The controller 1106 may return to step 1208 and repeat steps 1208 through 1214 until a selected number of cuts has been completed, a remaining length of the log 302 is below a threshold, or the operator terminates the sequence.

In some embodiments, the controller 1106 may adjust repositioning between sequential cuts to maintain or reduce angular deviation of the log 302 relative to the square cut line 1112. In some embodiments, the controller 1106 may account for a kerf of the cutting device 110, sensor tolerances, and dimensional allowances associated with downstream processing of the log 302 or cut workpieces.

In one example, an operator uses the grapple 300 to grasp a log 302 and places an opposite end of the log 302 adjacent the cutting device 110. The controller 1106 stores the grapple location 1100 and determines an initial log length 1102 and an angular deviation relative to the square cut line 1112 in one or more planes. If the angular deviation exceeds the maximum allowable cutting angle 1104 in one or more planes, such as where a measured angle is approximately 12° and a permitted threshold is 10°, the controller 1106 may reject the stored position and prompt the operator to reposition the log 302.

After an acceptable grapple location 1100 is stored, the controller 1106 may receive a selected cut length, such as 300 mm, 400 mm, 500 mm, or another operator-selected length. After each cut, the controller 1106 may raise the log 302 by a clearance distance, such as approximately 0.1 m, and reposition the grapple 300 by resolving the selected cut length into movement components based on the maximum allowable cutting angle 1104. The controller 1106 may command one or more of pivoting of the boom 1008, extension of the boom 1008, turntable slew, or other excavator movement to advance the log 302 for the next cut.

The controller 1106 may repeat the cycle until a selected number of cuts is completed, the remaining effective length of the log 302 is below a threshold, or further repositioning would violate a safety limit associated with the boom slew limiter 1000 and/or the turntable slew limiter 1012. In some embodiments, the controller 1106 may operate in a semi-automated mode in which the operator controls cutting movement of the excavator dozer blade 102 while the controller 1106 performs or assists with repositioning of the log 302 between cuts.

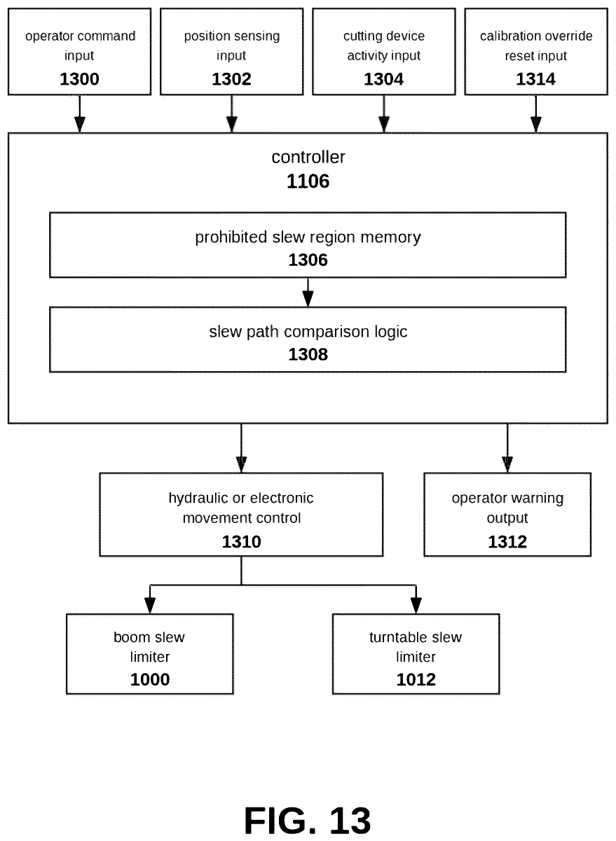

FIG. 13 shows a controller/system block diagram for implementing the boom slew limiter 1000, the turntable slew limiter 1012, or both in association with the cutting device 110. The controller 1106 may be a machine controller, attachment controller, safety controller, distributed control system, or other control component configured to evaluate commanded or predicted movement relative to a prohibited slew region and to output movement-permitting, movement-inhibiting, or warning controls according to an embodiment.

The operator command input 1300 may be one or more operator-requested movements to be evaluated before or during execution. The operator command input 1300 may include, for example, a boom slew command, a turntable slew command, a grapple command, an arm movement command, a boom movement command, or another excavator or attachment movement command that could move the boom, grapple, log, or another machine portion toward or away from the cutting device 110. In some embodiments, operator command input 1300 may be any combination of commands.

The position sensing input 1302 may be a sensed or calculated position information used to determine a spatial relationship between the moving equipment and the cutting device 110. The position sensing input 1302 may include, for example, boom position data, turntable angle data, grapple position data, cutting-device position data, proximity data, angular data, location data, or derived position data from one or more sensors. The position sensing input 1302 may be used by the controller 1106 to determine whether a requested or predicted movement path would approach, enter, remain outside, or move away from a prohibited slew region.

The cutting device activity input 1304 may be an operating state of the cutting device 110. The cutting device activity input 1304 may indicate whether the cutting device 110 is active, rotating, powered, lowering, cutting, recently operated, or otherwise in a state in which additional slew limiting, interlock control, spacing, warning, or movement inhibition is to be applied. In some embodiments, the controller 1106 may apply a different prohibited slew region, different movement threshold, or different response based at least in part on the cutting device activity input 1304.

Within or in association with the controller 1106, the prohibited slew region memory 1306 may store boundary data defining a prohibited or limited slew region relative to the cutting device 110. The prohibited slew region memory 1306 may store, for example, a maximum proximity line, an excluded turntable sector, a virtual wall, a geo-fence, a calibrated boundary, a buffer region around the cutting device 110, or other stored boundary information. The prohibited slew region memory 1306 feeds the slew path comparison logic 1308 so that the stored boundary data can be compared against a requested or predicted movement path.

The slew path comparison logic 1308 may be controller-executed logic configured to compare the operator command input 1300 and the position sensing input 1302 with the boundary data from the prohibited slew region memory 1306. The slew path comparison logic 1308 may further account for the cutting device activity input 1304. Based on the comparison, the slew path comparison logic 1308 may determine whether a requested or predicted boom, grapple, log, or turntable movement should be permitted, slowed, stopped, locked out, warned against, or otherwise inhibited.

The hydraulic or electronic movement control 1310 represents a control output, valve command, actuator command, lockout, electronic control signal, machine-control interface, or other movement-control function used to permit or restrict movement of the excavator or attachment. The controller 1106 may output to the hydraulic or electronic movement control 1310 to permit movement that remains outside the prohibited slew region or moves away from the cutting device 110, and to slow, stop, hydraulically inhibit, electronically inhibit, lock out, or otherwise restrict movement that enters or would enter the prohibited slew region. The hydraulic or electronic movement control 1310 may implement or drive the boom slew limiter 1000, the turntable slew limiter 1012, or both.

The operator warning output 1312 represents an output configured to alert an operator when a requested or predicted movement approaches, reaches, enters, or would enter the prohibited slew region. The operator warning output 1312 may include, for example, an audible warning, visual warning, haptic warning, display warning, indicator, alarm, or other operator-perceptible output. The controller 1106 may activate the operator warning output 1312 alone or in combination with movement control through the hydraulic or electronic movement control 1310. In some embodiments, the operator warning output 1312 may log the warning in a storage system and/or transmit the warning to a remote monitoring system.

The calibration override reset input 1314 represents an operator, service, or authorized input used to set, update, override, or reset the prohibited slew region or the slew limiting operation under defined conditions. The calibration override reset input 1314 may be used during installation, service, calibration, attachment change, boundary adjustment, or authorized override. In some embodiments, the calibration override reset input 1314 updates boundary data stored in the prohibited slew region memory 1306, and the controller 1106 thereafter applies the updated boundary data when operating the boom slew limiter 1000, the turntable slew limiter 1012, or both.

In some embodiments, the controller 1106 receives the operator command input 1300, the position sensing input 1302, and the cutting device activity input 1304 while a boom, grapple, log, or turntable movement is requested near the cutting device 110. The controller 1106 retrieves boundary data from the prohibited slew region memory 1306 and executes the slew path comparison logic 1308 to determine whether the requested or predicted movement would enter the prohibited slew region. If the movement remains outside the prohibited slew region or moves away from the cutting device 110, the controller 1106 permits movement through the hydraulic or electronic movement control 1310. If the movement would enter the prohibited slew region, the controller 1106 slows, stops, locks out, or otherwise inhibits the movement through the hydraulic or electronic movement control 1310 and may activate the operator warning output 1312.

In some embodiments, the calibration override reset input 1314 is used to set or update the boundary data stored in the prohibited slew region memory 1306. The controller 1106 then applies the updated boundary data when operating the boom slew limiter 1000, the turntable slew limiter 1012, or both.

In some embodiments, the controller 1106 may include one or more artificial intelligence (AI) or machine learning (ML) modules configured to perform calculations that are adjusted over time based on operational data. The AI/ML modules may analyze historical position data, cutting operations, sensor data, operator inputs, maintenance information, blade information, and movement patterns to refine boundary data stored in the prohibited slew region memory 1306, optimize repositioning calculations, or predict operator intent. For example, the AI/ML modules may learn from repeated cutting sequences to improve the accuracy of grapple repositioning calculations, reduce the frequency of rejected log positions, or anticipate operator movements to provide earlier warnings when approaching the prohibited slew region. In some embodiments, the AI/ML modules may adjust the maximum allowable cutting angle 1104, refine kerf compensation values, or modify clearance distances based on observed outcomes from prior cutting operations.

The AI/ML modules may further analyze near-miss events or warning activations to adaptively adjust the prohibited slew region or movement thresholds to improve safety margins while maintaining operational efficiency. In some embodiments, the AI/ML modules may identify patterns in operator behavior that correlate with increased risk of contact between the boom 1008, the grapple 300, or a held log 302 and the cutting device 110, and may proactively adjust safety boundaries or provide predictive alerts based on detected patterns. The controller 1106 may transmit operational data to a remote server for training or updating of AI/ML models, and may receive updated model parameters for local execution. In some embodiments, the AI/ML modules may operate in conjunction with the slew path comparison logic 1308 to provide enhanced prediction of movement paths, improved detection of hazardous conditions, or adaptive responses based on learned patterns of excavator operation. The AI/ML modules may further correlate environmental factors, such as log diameter, wood density, or cutting resistance, with optimal repositioning parameters (e.g., position information determined from sensors, cameras, etc.) to improve cutting consistency and reduce operator fatigue during extended firewood processing operations.

The AI/ML modules may include specialized modules configured for different operational tasks, including cutting modules, carrying modules, holding modules, breaking modules, hammering modules, pulverizing modules, pulling modules, grinding modules, or combinations thereof. Each module may be configured to analyze task-specific parameters and optimize performance for the corresponding operation. For example, a cutting module may analyze blade wear patterns, cutting resistance, and material properties to optimize cutting speed and blade engagement, while a breaking module may analyze impact force, material fracture characteristics, and structural integrity to optimize breaking efficiency.

The AI/ML modules may be trained using task-specific operational data to perform and optimize specific tasks. Training data may include cutting speeds, operational speeds, force data, pressure data, vibration data, temperature data, power consumption data, cycle time data, material response data, or combinations thereof. For example, a cutting module may be trained using historical data correlating cutting speed, blade rotational velocity, feed rate, and material density with cutting quality and blade longevity. The trained modules may generate optimized operational parameters based on detected conditions and learned relationships between input parameters and operational outcomes.

In some embodiments, the AI/ML modules may adapt operational parameters in real-time based on sensor feedback during task execution. The modules may detect changes in operational conditions, such as increased cutting resistance indicating a change in material density or the presence of a knot in timber, and may automatically adjust operational parameters to maintain optimal performance. The AI/ML modules may further log operational data during task execution for subsequent analysis, model refinement, or predictive maintenance scheduling. In some embodiments, the AI/ML modules may communicate with remote servers to receive updated model parameters or to transmit operational data for fleet-wide learning across multiple excavator systems.

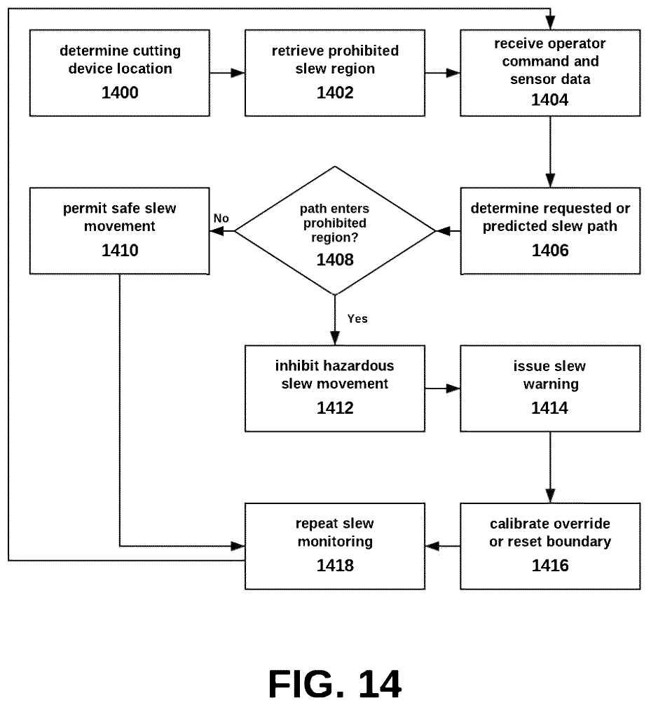

FIG. 14 illustrates a flow chart of a slew limiting method for the excavator dozer blade attachment 104 and the cutting device 110. The method may be performed by the controller 1106 to evaluate commanded or predicted boom, grapple, log, or turntable movement relative to a prohibited slew region and to permit or inhibit movement of the excavator 100.

At step 1400, a cutting device location is determined. The controller 1106 may determine a current, stored, calibrated, sensed, or calculated location of the cutting device 110 relative to the excavator 100. The location may be based on the saw position sensor 1110, stored installation geometry of the excavator dozer blade attachment 104, a known position of the excavator dozer blade 102, a calibrated cutting-device position, or other position data for the cutting device 110.

At step 1402, a prohibited slew region is retrieved. The prohibited slew region may define a boundary around, near, or relative to the cutting device 110 in which boom, grapple, log, or turntable movement is limited or prevented. The prohibited slew region may include the maximum proximity of boom to saw 1002, a boundary associated with the boom slew limiter 1000, a sector associated with the turntable slew limiter 1012, a virtual wall, a geo-fence, a buffer region, or boundary data stored in the prohibited slew region memory 1306.

At step 1404, operator command and sensor data are received. The controller 1106 may receive the operator command input 1300, the position sensing input 1302, the cutting device activity input 1304, or any combination thereof. The received data may include, for example, a boom slew command, a turntable slew command, a grapple command, boom position data, turntable angle data, grapple position data, cutting-device activity data, proximity data, angular data, or location data used to evaluate movement relative to the prohibited slew region.

At step 1406, a requested or predicted slew path is determined. The controller 1106 may determine the requested or predicted slew path from the operator command and sensor data received at step 1404. The requested or predicted slew path may represent anticipated movement of the boom 1008, the grapple 300, a log 302 held by the grapple 300, an upper structure of the excavator 100, or another movable component relative to the cutting device 110.

At step 1408, the requested or predicted slew path is compared with the prohibited region. The controller 1106 may execute the slew path comparison logic 1308 to compare the requested or predicted slew path from step 1406 with the prohibited slew region retrieved at step 1402. The comparison may determine whether the requested or predicted slew path enters the prohibited region, would enter the prohibited region if allowed to continue, approaches the prohibited region, remains outside the prohibited region, or moves away from the cutting device 110. In some embodiments, the comparison may further account for whether the cutting device activity input 1304 indicates that the cutting device 110 is active, rotating, powered, lowering, cutting, or recently operated.

At step 1410, safe slew movement is permitted. The controller 1106 may permit movement through the hydraulic or electronic movement control 1310 when the comparison at step 1408 indicates that the requested or predicted slew path remains outside the prohibited slew region, moves away from the cutting device 110, or otherwise satisfies a stored safety threshold. The permitted movement may include boom slew, turntable slew, grapple movement, arm movement, or another movement that does not encroach into the prohibited slew region.

At step 1412, hazardous slew movement is inhibited. The controller 1106 may use the hydraulic or electronic movement control 1310 to slow, stop, hydraulically inhibit, electronically inhibit, lock out, or otherwise restrict movement when the comparison at step 1408 indicates that the requested or predicted slew path enters or would enter the prohibited slew region. The inhibited movement may be movement of the boom 1008, the grapple 300, the log 302, an upper structure of the excavator 100, or another movable component toward the cutting device 110. Step 1412 may implement the boom slew limiter 1000, the turntable slew limiter 1012, or both.

At step 1414, a slew warning is issued. The controller 1106 may activate the operator warning output 1312 when the requested or predicted slew path approaches, reaches, enters, or would enter the prohibited slew region. The warning may be an audible warning, visual warning, haptic warning, display warning, indicator, alarm, or other operator-perceptible output, and may be issued alone or together with movement inhibition at step 1412.

At step 1416, a boundary is calibrated, overridden, or reset. The controller 1106 may receive the calibration override reset input 1314 to set, update, override, or reset the prohibited slew region or the slew limiting operation under defined conditions. The calibration, override, or reset may be used during installation, service, attachment change, boundary adjustment, authorized override, or recovery from a stopped condition. In some embodiments, the calibration override reset input 1314 updates boundary data stored in the prohibited slew region memory 1306.

At step 1418, slew monitoring is repeated. The controller 1106 may return to step 1404 during operation so that operator commands and sensor data are repeatedly evaluated against the prohibited slew region. The controller 1106 may return to step 1400 or step 1402 when the cutting device location or the prohibited slew region is updated, and may continue to permit safe slew movement, inhibit hazardous slew movement, issue warnings, or apply updated boundary data during operation.

In some embodiments, the controller 1106 performs the method of FIG. 14 while the excavator dozer blade attachment 104 carries the cutting device 110 at the excavator dozer blade 102. The controller 1106 may determine cutting device location 1400, retrieve prohibited slew region 1402, receive operator command and sensor data 1404, determine requested or predicted slew path 1406, and compare path with prohibited region 1408 using the slew path comparison logic 1308.

If the requested or predicted slew path remains outside the prohibited slew region or moves away from the cutting device 110, the controller 1106 may permit safe slew movement 1410 through the hydraulic or electronic movement control 1310. If the requested or predicted slew path enters or would enter the prohibited slew region, the controller 1106 may inhibit hazardous slew movement 1412 and issue slew warning 1414 through the operator warning output 1312. The controller 1106 may calibrate override or reset boundary 1416 when the calibration override reset input 1314 is received, and may repeat slew monitoring 1418 during operation.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

What is claimed is:

1. An excavator dozer blade attachment comprising:
a mounting device configured to engage a dozer blade of an excavator;
a cutting device coupled to the mounting device and including at least one of a chainsaw or a circular saw; and
a drive motor operatively coupled to the cutting device to rotatably drive the cutting device.

2. The excavator dozer blade attachment of claim 1, wherein the mounting device is configured to at least one of: clamp onto the dozer blade, hook onto the dozer blade, wedge onto the dozer blade, or attach to the dozer blade using fasteners comprising screws, bolts, chains, or turnbuckles.

3. The excavator dozer blade attachment of claim 1, wherein the mounting device comprises a hooked-over clamp configured to be tightened against the dozer blade by one or more turnbuckles.

4. The excavator dozer blade attachment of claim 1, wherein the drive motor is a hydraulic motor configured to receive hydraulic fluid from a hydraulic circuit of the excavator.

5. The excavator dozer blade attachment of claim 1, wherein the drive motor comprises an independent power source configured to power the cutting device without requiring power from the excavator.

6. The excavator dozer blade attachment of claim 5, wherein the independent power source is controllable from an operator position of the excavator.

7. The excavator dozer blade attachment of claim 1, further comprising a frame extension coupled between the mounting device and the cutting device, wherein the frame extension positions the cutting device at an elevated height above the dozer blade.

8. The excavator dozer blade attachment of claim 7, wherein the frame extension is adjustable in length to define a selectable maximum raised height and a selectable minimum lowered height for the cutting device.

9. The excavator dozer blade attachment of claim 7, wherein the frame extension is configured such that a range of vertical travel of the cutting device, determined by a range of motion of the dozer blade, is sufficient to drive the chainsaw or circular saw through a log supported adjacent the cutting device.

10. The excavator dozer blade attachment of claim 7, further comprising a support structure configured to support a log at a position adjacent the cutting device during a cutting operation.

11. The excavator dozer blade attachment of claim 10, wherein the support structure is positionable on a ground adjacent the excavator and is adjustable for a target cutting height and a target cut length.

12. The excavator dozer blade attachment of claim 1, wherein the cutting device comprises a circular saw blade configured to cut at least one of timber, rock, concrete, metal, or plastic.

13. The excavator dozer blade attachment of claim 1, further comprising at least one of a log splitter or a log elevator coupled to the excavator dozer blade attachment or to a support structure associated with the excavator dozer blade attachment.

14. A method of processing a workpiece using an excavator comprising a dozer blade, a boom, a stick, and a grapple, the method comprising:
gripping the workpiece with the grapple;
positioning the workpiece beneath a cutting device of an excavator dozer blade attachment mounted on the dozer blade;
lowering the dozer blade to drive the cutting device through the workpiece to produce a cut piece of a selected length;
raising the dozer blade after completing the cut; and
repositioning the workpiece with the grapple to a next cutting position and repeating the lowering and cutting.

15. The method of claim 14, wherein repositioning the workpiece comprises moving the workpiece using at least one of boom movement, stick movement, swing movement, or a combination thereof.

16. The method of claim 14, further comprising a safety interlock circuit configured to inhibit movement of at least one of the boom, the stick, the grapple, or an upper structure of the excavator into a restricted region adjacent the cutting device while a drive motor is operating.

17. The method of claim 14, further comprising at least one proximity sensor mounted on the excavator or on the excavator dozer blade attachment, the at least one proximity sensor configured to detect a person within a predefined safety zone and, upon detection, disable at least one of a drive motor and movement of the excavator.

18. The method of claim 14, further comprising restricting a swing range of the grapple to a predefined arc that excludes a spatial zone occupied by the cutting device.

19. The method of claim 14, further comprising:
storing an initial grapple position when an end of the workpiece contacts the cutting device during a first cutting operation;
calculating, using a trigonometric relationship between the initial grapple position, a boom pivot point of the excavator, a location of the cutting device, and a target cut length, a repositioning of the grapple required for each successive cutting operation to reduce an effective held length of the workpiece by the target cut length while maintaining a cutting angle within a maximum allowable cutting angle from a square cut line; and
automatically repositioning the grapple to the calculated repositioning for each successive cutting operation.

20. The method of claim 14, wherein the selected length is selected by an excavator operator, is predetermined programmatically, or is retrieved from a stored cut list.
